(19) United States
(12) Patent Application Publication
(10) Pub. No.: US 2013/0175254 A1
(43) Pub. Date: Jul. 11, 2013

(54) COOK TOP APPLIANCE HAVING SPILL AND BOIL-OVER DETECTION AND RESPONSE

(71) Applicants: James Carter Bach, Seymour, IN (US); Paul Bryan Cadima, Prospect, KY (US)

(72) Inventors: James Carter Bach, Seymour, IN (US); Paul Bryan Cadima, Prospect, KY (US)

(73) Assignee: GENERAL ELECTRIC COMPANY, Schenectady, NY (US)

(21) Appl. No.: 13/346,857

(22) Filed: Jan. 10, 2012

(51) Int. Cl. H05B 3/68; H05B 1/02

(52) U.S. Cl. 219/447.1

(57) ABSTRACT

A cook top appliance that can detect a food deposit on the cook top surface from a spill or boil-over is provided. A sensor zone that surrounds a heating source is used to detect the food deposit. Based on the detection of the food deposit, the cook top appliance can take one or more remedial actions to e.g., notify the user and/or modify the operation of the heating source. A variety of configurations of the sensor zone are described.

### FIELD OF THE INVENTION

The subject matter of the present disclosure relates to a cook top appliance that can determine whether a spill or boil-over event has occurred and, if so, undertakes one or more remedial responses.

### BACKGROUND OF THE INVENTION

Cook top appliances typically can include a variety of configurations for the heating sources located on the cook top surface. The number of heating sources or positions available for heating on the cook top can include e.g., four, six, or more depending upon the intended application and preferences of the buyer. These heating sources can vary in size and location along the surface of the cook top. Further, the types of heating sources available include, for example, gas burner, electric resistance (e.g., hot coil), electric radiant, and induction. For cook top appliances having a glass or ceramic surface for receipt of the cooking utensils, the heating sources can include e.g., include radiant, induction, and gas on glass. A variety of controls can be provided for such heating sources such as e.g., traditional rotatable knobs and/or electronic types that rely on sensitivity to a user's touch.

Cook tops have traditionally relied upon an operator/user to monitor cooking activity and temperatures during use. Attention to whether food is boiling, simmering, or otherwise at a certain temperature and/or for a certain period of time can be important for determining whether proper cooking has occurred. However, during the cooking process where a pot or other utensil is being heated by the cook top, a user of the cook top appliance may become distracted or otherwise pre-occupied and forgo timely monitoring of the food and/or liquid in the utensil. As a result, depending upon the amount of food and/or liquid present within the vessel, a boil-over may occur whereby the side of the utensil and/or and the cook top surface becomes soiled by the liquid food item. As used herein, “boil-over” refers to a condition where food, liquids, or both escape from a cooking utensil (such as e.g., a pot, pan, etc.) because of the application of too much heat—thereby causing the food and/or liquid to boil over, pop, bubble, splatter, or otherwise leave the utensil and travel onto the surface of a cook top. As used herein, “spill” refers to a condition where foods, liquids, or both are accidently deposited onto the cook top surface because of movement of cooking utensils or other cooking paraphernalia by the user. For example, while pouring a liquid ingredient into the cooking vessel, some of the liquid might splash out of the cooking utensil or the user might have misaligned the pouring device and the cooking vessel and directly deposited the liquid onto the cook top surface. As used herein, “food deposit” will refer to the placement of food (liquid and/or solid) onto the cook top surface from a spill, boil-over, or both. When an unwanted food deposit occurs on the cook top surface, if left untreated, it can cause damage to the cooking surface—particularly in the case of the electric radiant type wherein the surface is extremely hot underneath and in the immediate vicinity of the cooking utensil.

For a cook top appliance having a glass or ceramic surface, such events are particularly undesirable. Depending upon the amount of the contamination and the temperature of the surface, cleaning can be very difficult. For example, if the contamination is allowed to remain long enough under sufficient heat, the contaminant could eventually char onto the glass surface and will be extremely difficult to remove afterwards. While the user may be able to remove some of the char residue from the glass surface, permanent damage can occur, particularly in the case of sugar-based substances which can permanently etch the glass surface. The glass surface may remain stained or otherwise damaged even after thorough cleaning.

Accordingly, a cook top appliance that can determine whether a spill or boil-over has occurred onto the surface of the cook top would be useful. Such an appliance that can also undertake one or more remedial actions in response to the detection of a spill or boil-over would be particularly beneficial. The ability to provide such monitoring and response for cook tops with radiant, induction, or gas-on-glass heating sources would also be useful.

### BRIEF DESCRIPTION OF THE INVENTION

Aspects and advantages of the invention will be set forth in part in the following description, or may be obvious from the description, or may be learned through practice of the invention.

In one exemplary embodiment, the present invention provides a cook top appliance having a cooking surface. The appliance includes a heating source for applying a heat input to a cooking utensil placed upon the cooking surface. A sensor zone surrounds the heating source. The sensor zone includes at least one sensor for detecting a food deposit from the cooking utensil. A controller is in communication with the sensor zone. The controller is configured for detecting a signal from the sensor zone that is indicative of the food deposit from the utensil and altering the heat input provided by the heating source once a signal indicative of the food deposit is detected.

In still another exemplary aspect of the present invention, a method for operating a cook top appliance having a heating source surrounded by a sensor zone is provided. The sensor zone includes at least one sensor. The method includes the steps of providing heat to a substance in a utensil placed on the heating source; monitoring the sensor zone to detect a spill-over condition and, if a spill-over is detected, then adjusting the heating source so as reduce or terminate the heating of the substance in the utensil; and, optionally, providing a notification to a user of the appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of an exemplary embodiment of a cook top appliance having e.g., a glass surface. The dashed lines show the location of heating sources and sensor zones, the construction of which is shown more particularly in other figures.

FIGS. 2-3 illustrate perspective views of exemplary embodiments of heating sources with exemplary sensor zones as can be configured with the cook top appliance of FIG. 1.

FIGS. 4-7 provide perspective views of additional exemplary embodiments of sensor zones as can be configured with the heating sources of the cook top appliance of FIG. 1.

Exemplary configurations for the positioning of sensors on the cook top appliance are illustrated in the cross-sectional views of FIGS. 8-11.

Exemplary configurations for the positioning of detection sensors within or below the material forming the cook top surface are illustrated in the cross-sectional views of FIGS. 12 and 13.

### DETAILED DESCRIPTION OF THE INVENTION

The present invention relates to a cook top appliance that can detect a food deposit from a boil-over or spill by which the food is deposited onto a cook top surface. A sensor zone that surrounds a heating source of the cook top is used to detect the food deposit. Based on the detection of the food deposit, the cook top appliance can take remedial action to e.g., notify the user and/or modify the operation of the heating source. A variety of configurations of the sensor zone are described.

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

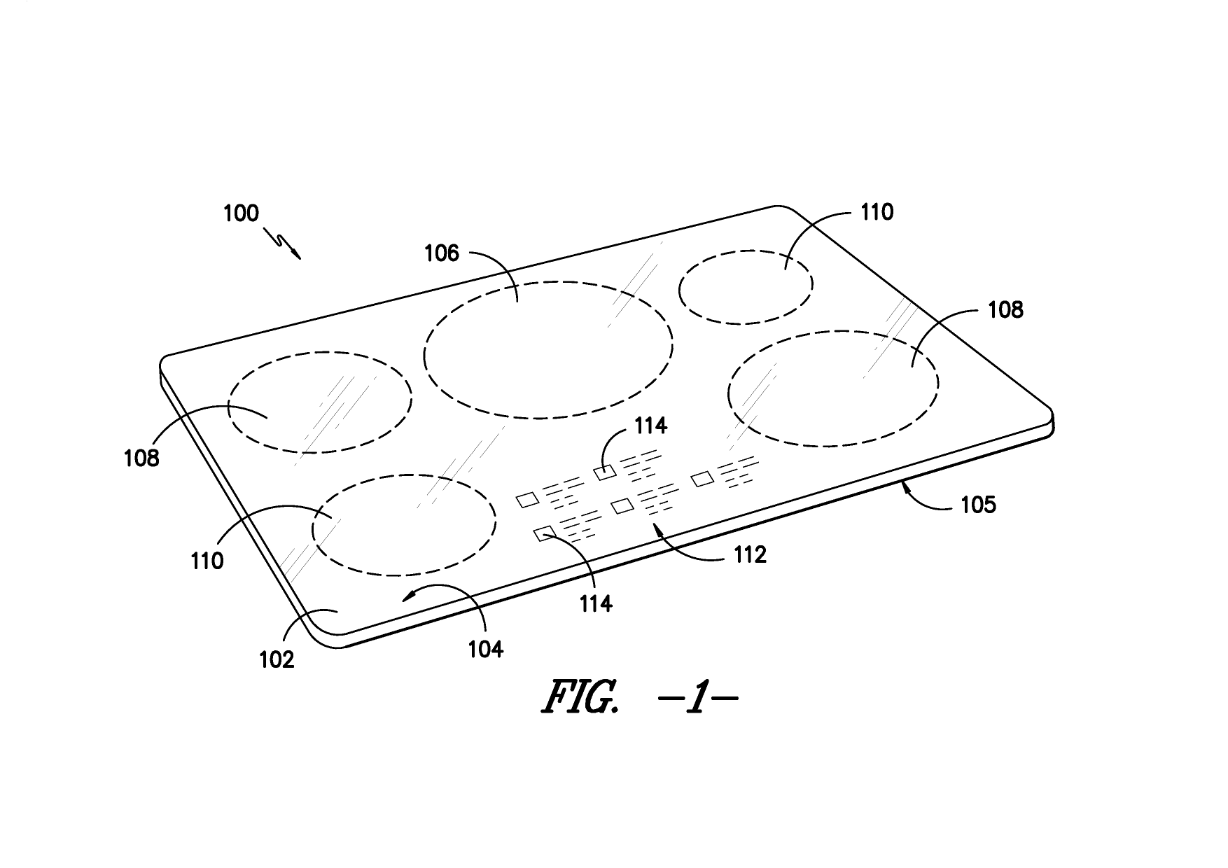

FIG. 1 illustrates an exemplary embodiment of a cook top appliance 100 as may be employed with the present invention. Cook top 100 includes a non-metallic material 102 that provides a cooking surface 104. By way of example, non-metallic material 102 may be constructed from glass, ceramics, and combinations thereof. Heat elements 106, 108, 110 can be configured in various sizes as shown so as to provide e.g., for the receipt of cooking utensils (i.e., pots, pans, etc.) of various sizes and configurations and to provide different heat inputs for such cooking utensils. For cook top 100, a utensil holding food and/or cooking liquids (e.g., oil, water, etc.) is placed directly onto the cooking surface 104 at a location of any of heating sources 106, 108, and 110.

Heating sources 106, 108, and 110 can have a variety of constructions for the input of energy in the form of heat to the cooking utensils. For example, heating sources 106, 108, and 110 can be constructed as electric radiant, electric induction, or gas-on-glass heating sources. Mechanisms associated with each such type of heating source are positioned under cooking surface 104 and will be well understood of one of skill in the art using the teachings disclosed herein.

A user interface panel 112 is located within convenient reach of a user of the appliance 100. For this exemplary embodiment, panel 112 includes touch-type controls 114 that are each associated with one of heating sources 106, 108, and 110. Controls 114 allow the user to activate each heating source and determine the amount of heat input provided by each such element 106, 108, and 110 to a cooking utensil location thereon. Panel 112 may also be provided with one or more graphical display devices that deliver certain information to the user such as e.g., whether a particular heating source is activated and/or the level at which the element is set.

Operation of cooking appliance 100 can be regulated by a controller (not shown) that is operatively coupled i.e., in communication with, user interface panel 112 and heating sources 106, 108, and 110. For example, in response to user manipulation of the control 114 of user interface panel 112, the controller operates one of heating source 110 . The controller is also provided with other features as will be further described herein. By way of example, the controller may include a memory and one or more processing devices such as microprocessors, CPUs or the like, such as general or special purpose microprocessors operable to execute programming instructions or micro-control code associated with operation of appliance 100. The memory may represent random access memory such as DRAM, or read only memory such as ROM or FLASH. In one embodiment, the processor executes programming instructions stored in memory. The memory may be a separate component from the processor or may be included onboard within the processor.

The controller may be positioned in a variety of locations throughout appliance 100. In the illustrated embodiment, the controller may be located under or next to the user interface panel 112. In such an embodiment, input/output (“I/O”) signals are routed between the controller and various operational components of appliance 100 such heating sources 106, 108, and 110, controls 114, sensors, graphical displays, and/or one or more alarms as will be further described. In one embodiment, the user interface panel 112 may represent a general purpose I/O (“GPIO”) device or functional block.

Although shown with touch type controls 114, it should be understood that controls 114 and the configuration of appliance 100 shown in FIG. 1 is provided by way of example only. More specifically, user interface 112 may include various input components, such as one or more of a variety of electrical, mechanical or electro-mechanical input devices including rotary dials, push buttons, and touch pads. The user interface 112 may include other display components, such as a digital or analog display device designed to provide operational feedback to a user. The user interface 112 may be in communication with the controller via one or more signal lines or shared communication busses. The user interface may be located on a different surface of the appliance, for instance, the angled front edge or the vertical backsplash. Heating sources of different shapes, locations, and configurations other than as shown in FIG. 1 may be used as well.

Cooking surface 104 provides an appearance with aesthetics that attract certain consumers. During use, it is desirable to keep cooking surface 104 clean. As described above, however, if a food deposit from a spill or boil-over occurs during use, cooking surface 104 can become soiled. Depending upon e.g., the identity of the substance that spills over, the temperature of the heating source, and the time the substance is allowed to remain in place with the application of heat, the appearance of cooking surface 104 could be permanently stained or damaged.

Accordingly, heating sources 106, 108, and 110 can each be equipped with a sensor zone for detecting a spill-over from a utensil. Based on the detection of the food deposit, appliance 100 can take certain remedial actions. For example, using a controller that is in communication with the sensor zone, once a food deposit is detected, the controller can be configured for remedial action such as providing an audible and/or visual alert to the user of the appliance. This alert could be built-into the appliance, such as a buzzer and/or flashing light, or could be issued to a remote device, such as a text message to the user's cellular telephone or an e-mail to the user's home computer. Alternatively, or in addition thereto, the remedial action could include terminating the operation of the heating source where the spill-over occurred or reducing the heat input from such heating source.

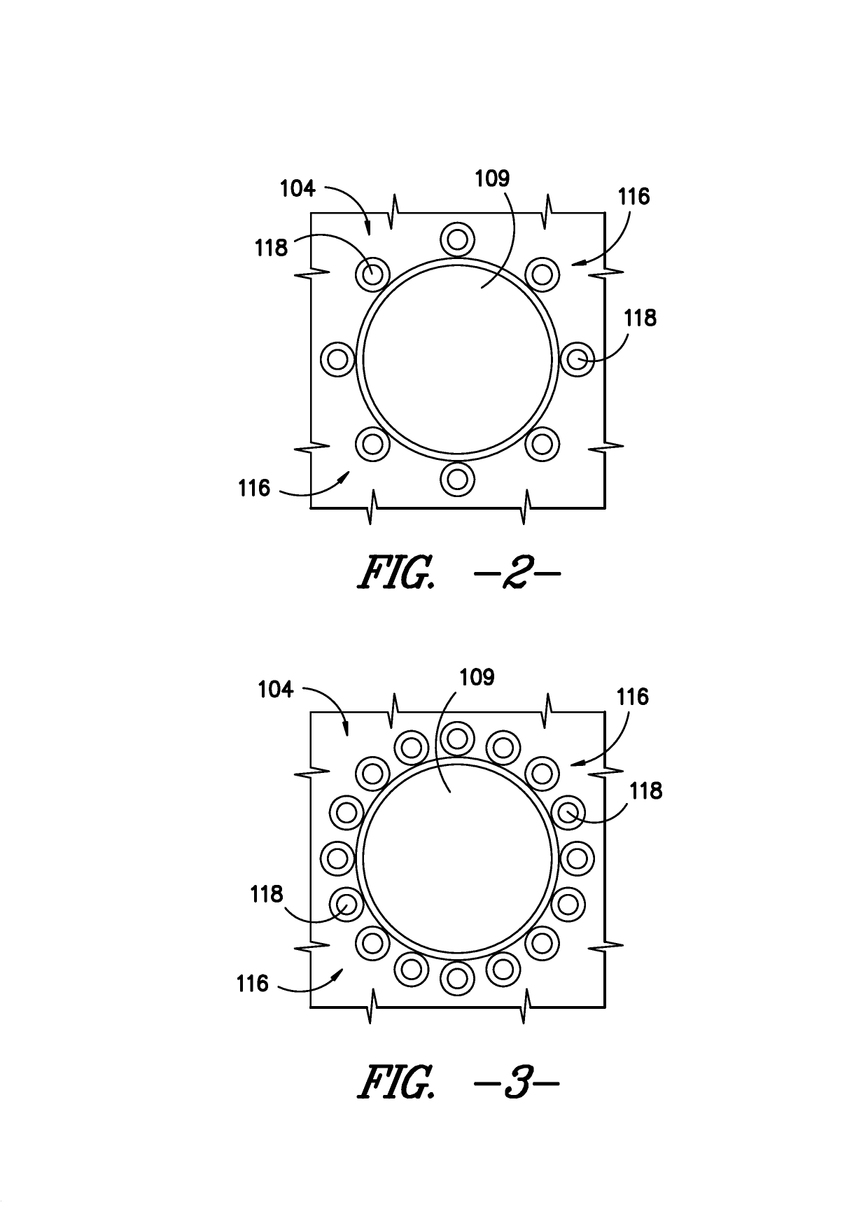

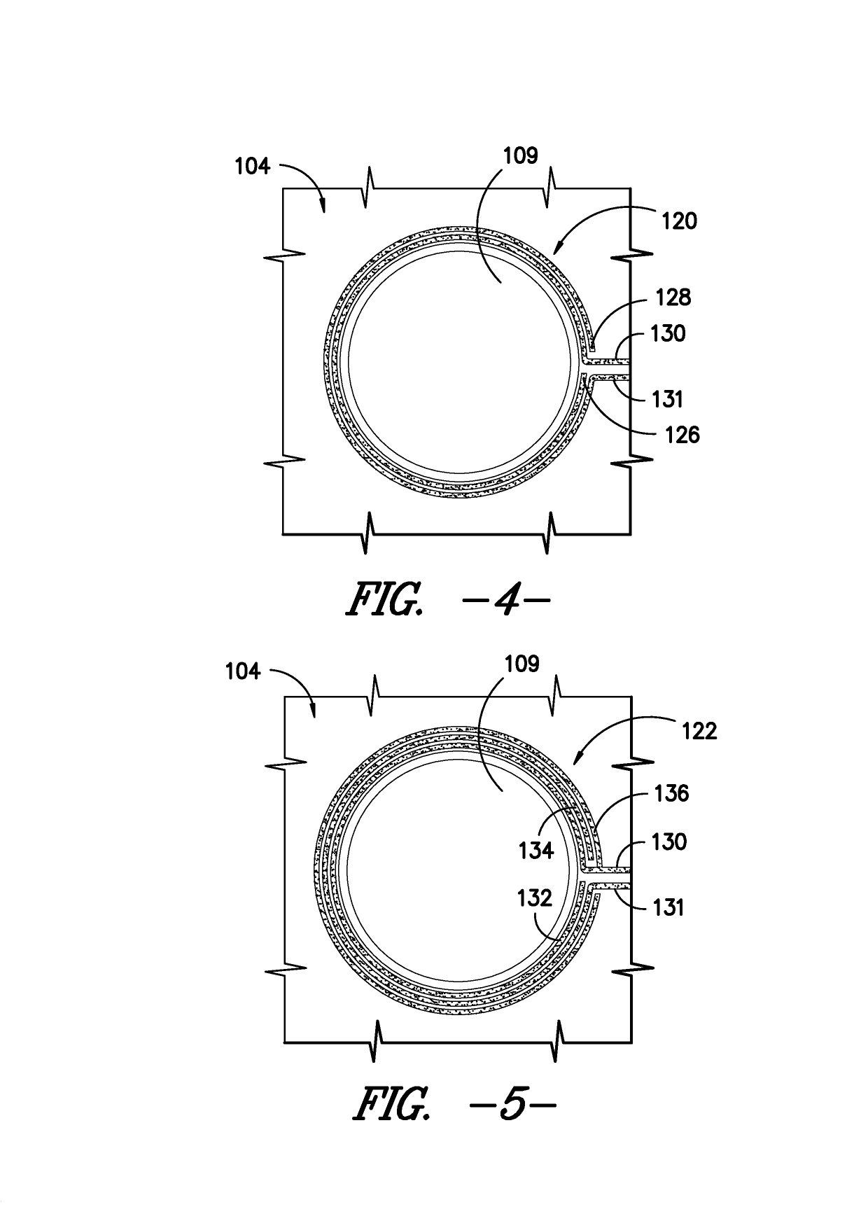

FIGS. 2 and 3 provide exemplary embodiments of how any one of heating source 106, 108, and 110 may be equipped with spill-over detection. Using a heating source 109 by way of example, such element is equipped with a sensor zone 116 that surrounds heating source 109. As used herein, “surrounds” or “surrounding” means that the sensor zone encloses heating source 109 on all sides as shown e.g., in FIGS. 2 and 3. In this way, sensor zone 116 helps ensure that a spill-over does not remain undetected due to a sensor placement that is only on one side of the heating source 109.

For the exemplary embodiments of FIGS. 2 and 3, sensor zone 116 includes a plurality of optical—and in this embodiment—infrared sensors 118 that encircle heating source 109. For example, such infrared sensors 118 might be located directly below and adjacent the bottom surface 105 (FIG. 1) of non-metallic material 102—opposite cooking surface 104. Each infrared sensor 118 includes an infrared source such as an LED or LASER and an infrared detector such as a phototransistor or photodiode. In the absence of liquid on surface 104, the infrared light emitted from the source is substantially reflected—by internal refraction within the non-metallic material 102—to the infrared detector. Of course, it should be noted that light wavelengths other than infrared could be used.

However, if a food deposit occurs during use of cook top 100, the presence of liquid material on cooking surface 104 at a location above one of sensors 118 will change the reflection of the infrared light. For example, some of the infrared light may be absorbed by, or deflected into, the spill-over. As a result, the amount of infrared light detected by the detector of sensor 118 will change. Each sensor 118 is in communication with the controller. This change in the amount of infrared light detected provides a signal to the controller that is indicative of a food deposit from a utensil placed on heating source 109. Upon detecting this signal, the controller can initiate remedial action such as reducing or terminating the heat input from heating source 109, and/or providing an alarm to the user, which could be a visible indication, audible indication, or a combination thereof.

FIGS. 2 and 3 provide examples of the placement of sensors 118. FIG. 3 provides a more preferable configuration in that the increased number of sensors 118 in the embodiment of FIG. 3 relative to FIG. 2 increases the accuracy of detection of a spill-over. Other configurations, including different placements and shapes, may be used for sensors 118 as well. Additionally, sensors 118 are not limited to infrared as other optical sensors may be used as well.

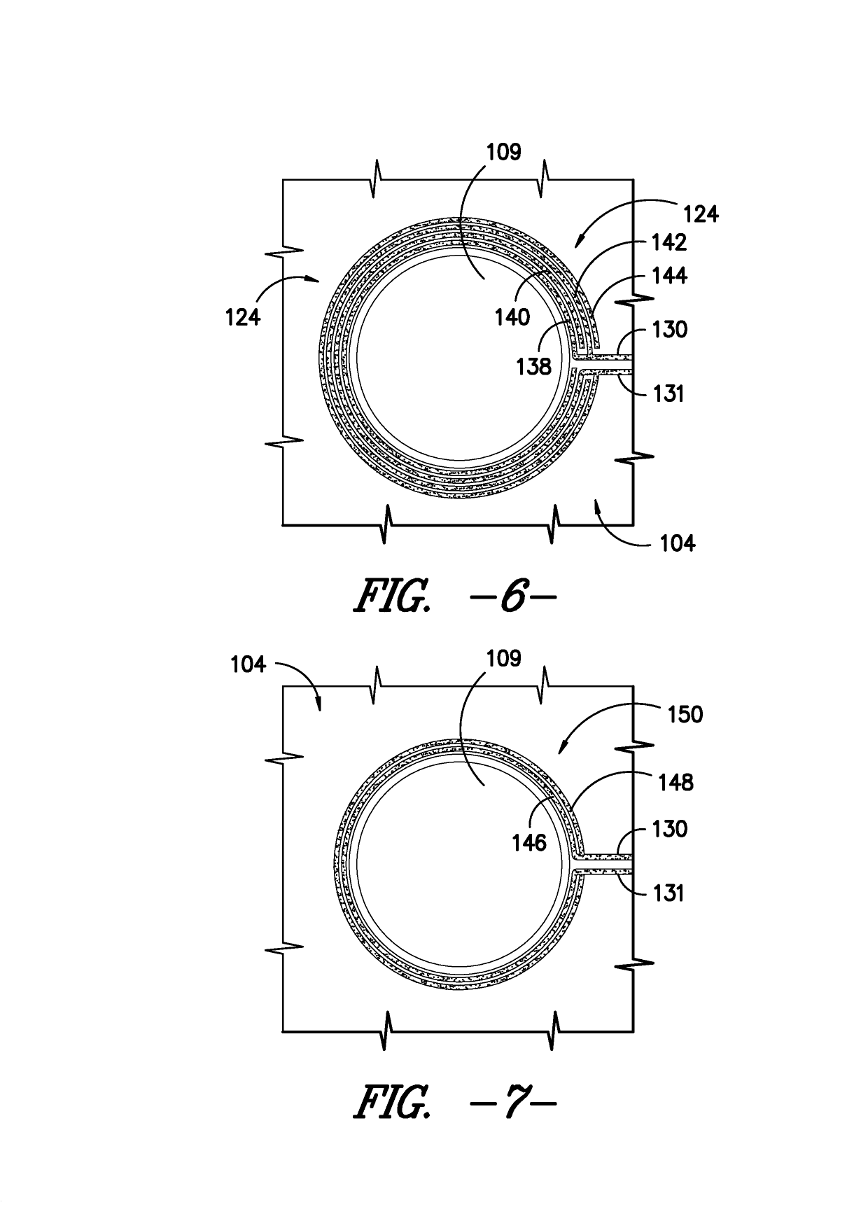

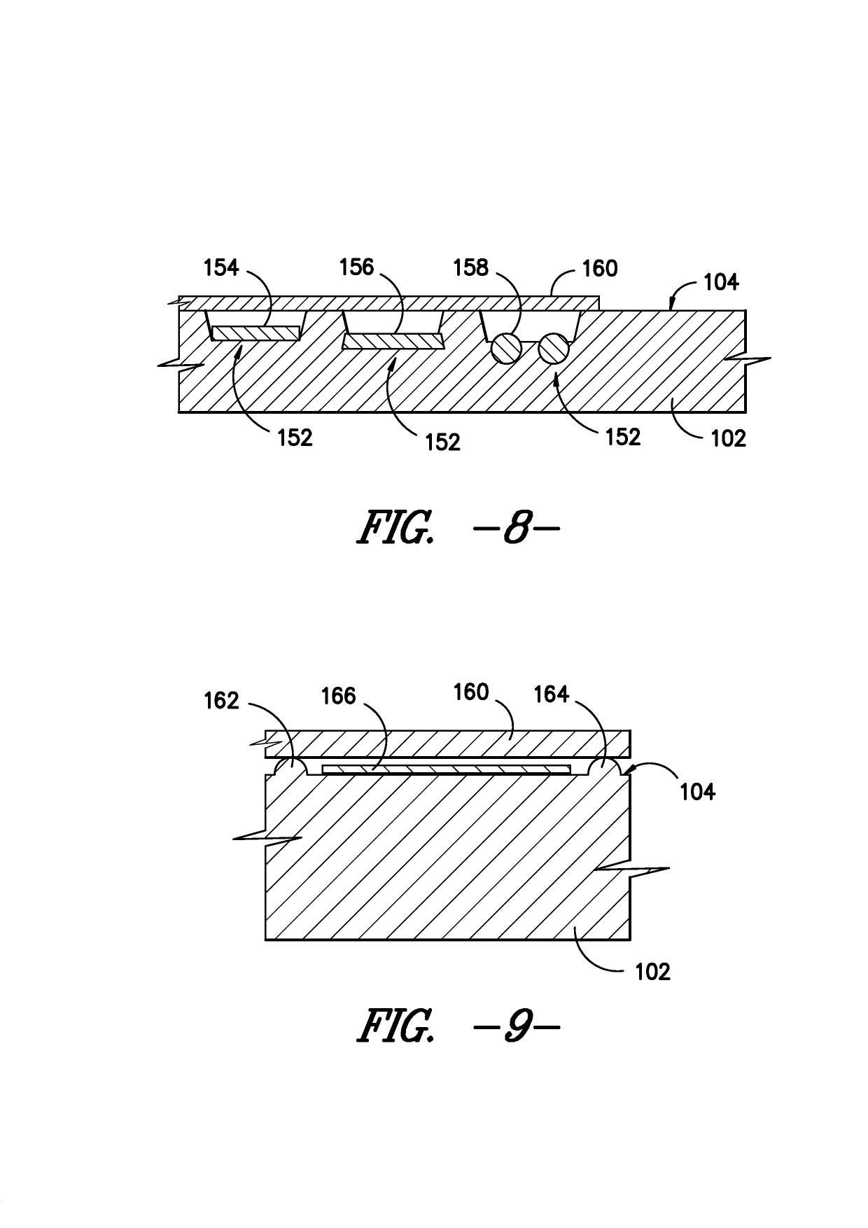

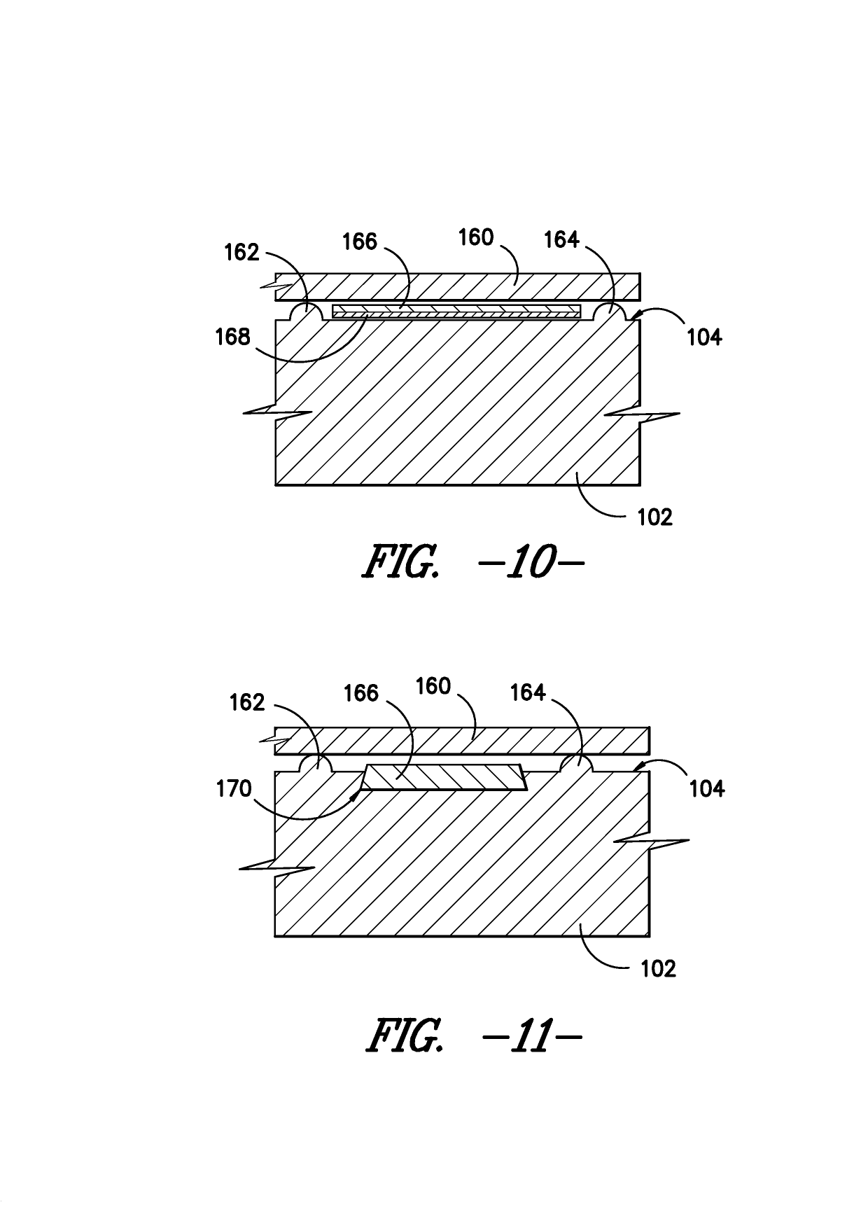

FIGS. 4-7 illustrate various exemplary embodiments of heating source 109 with alternative sensor zones 120, 122, 124, and 150, respectively. In FIG. 4, sensor zone 120 includes a pair of electrically conductive, concentric rings 126 and 128 that surround heating source 109 and extend from a pair of leads 130, 131; each concentric ring forms an electrode, with the detection circuitry requiring 2 electrodes per sensing region. In FIG. 5, sensor zone 122 includes three electrically conductive, concentric rings 132, 134, and 136 that surround heating source 109 and extend from the pair of leads 130, 131; concentric rings 132 and 136 are electrically connected, and form one electrode which surrounds the electrode formed by concentric ring 134. Similarly, in FIG. 6, sensor zone 124 includes four, electrically conductive, concentric rings that surround heating source 109 and extend from the pair of leads 130, 131; concentric rings 138 and 142 are electrically connected and form one electrode, while concentric rings 140 and 144 form a second electrode. For each zone 120, 122, and 124 in FIGS. 4-6, the concentric ring(s) associated with lead 130 (i.e. electrode #1) interdigitates with the ring(s) associated with lead 131(i.e. electrode #2)—but without overlapping or connecting the electrodes.

Other configurations of the rings may be used as well. In each case, the rings are positioned around the heating source 109 and preferably not directly over a heating source. Additionally, the rings are preferably located in a manner that places all, or at least a portion, of the rings just outside the diameter or foot print of a cooking utensil placed on heating source 109. In this way, when a food deposit occurs, food and/or liquid of the food deposit will be placed directly over and/or in contact with the rings so as to provide a signal that can be detected by the controller.

By way of example, the concentric rings in each of the sensor zones 120, 122, and 124, can be employed as capacitance-based, or resistance-based, sensors. One of leads e.g., lead 130 acts as one node (electrode) while the other lead 131 acts as the other node (electrode). An electrical signal is placed on e.g., one lead 130 while the other lead 131 acts as a ground. When a food and/or liquid from a spill-over covers at least two of the rings of a sensor zone 120, 122, or 124, the signal is diverted to ground which will, e.g., create a voltage change that can be detected by the controller as indicative of the spill-over. In the case of resistance (impedance, conductance) detection, there is direct flow of electricity from one electrode to the other, for instance, from lead 130, through the liquid, into lead 131. As such, an AC or DC signal may be used. This operation is similar to water detectors one might purchase at a home improvement store for monitoring the area under a sink or behind a refrigerator or washing machine for water leaks. In the case of capacitance detection, an AC (or pulsed DC) signal is used, The AC signal (or edges of a pulsed DC signal) is capacitively coupled from the first electrode to the liquid to be detected, and then capacitively coupled from the liquid to the second electrode. Detection schemes based on a resonance shift caused by a spill-over covering at least two rings can also be used. For detection schemes based as described on capacitance or resonance, the electrically-conductive rings can be placed on the top 100 or bottom 105 of the non-metallic material 102 and if located on the top surface the electrodes would normally be encased within material 102, or otherwise protected from direct contact with the cooking utensils by means of a high-temperature, scratch-resistant, non-electrically-conductive coating. For detection schemes based as described on resistance (conductivity), the electrically-conductive rings would be placed on the top 100 surface of the non-metallic material 102, and left exposed so as to be able to come in electrical communication with the fluid to be detected.

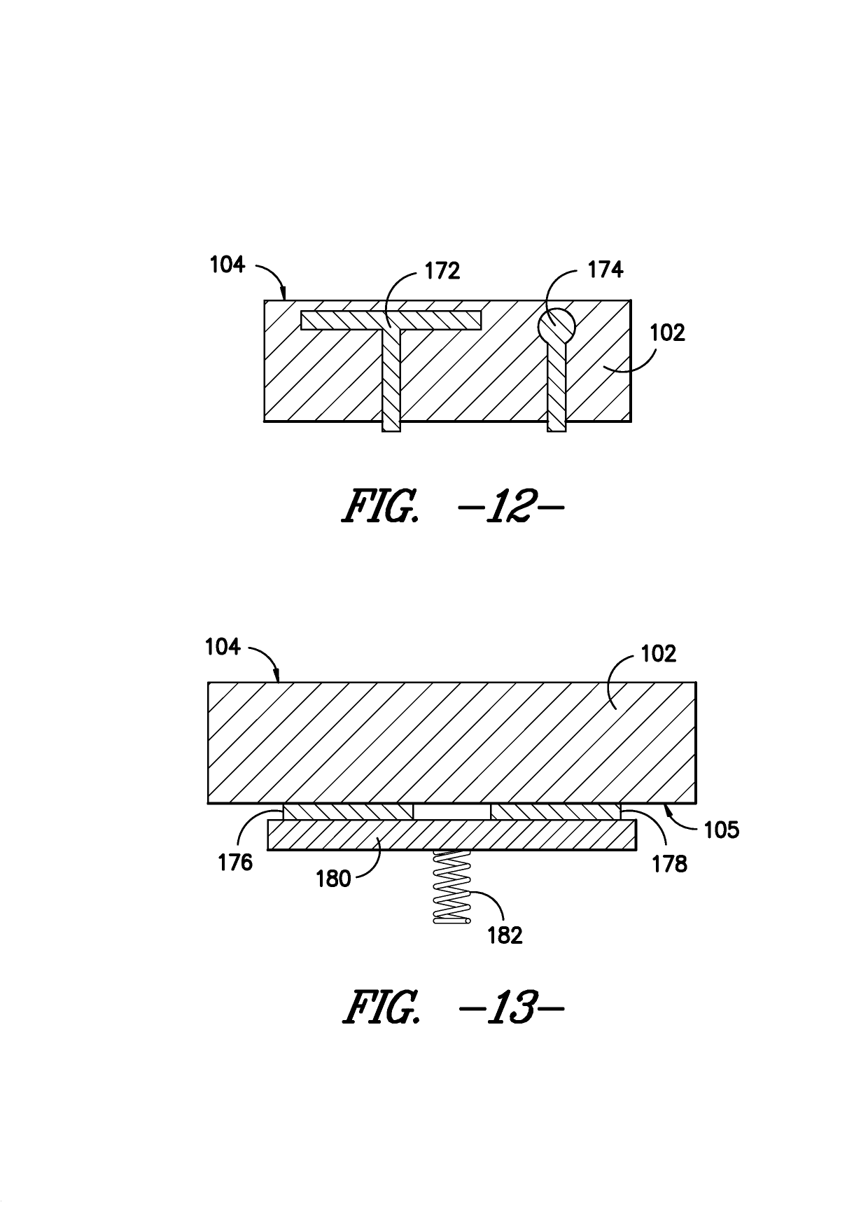

Other sensing schemes using a sensor zone that surrounds heating source 109 may be used well. For example, FIG. 7 provides another exemplary embodiment of a sensor zone 150 with electrically conductive, concentric rings 146 and 148 that are connected to each other as well as to leads 130 and 131. For this embodiment, sensor 150 acts as a resistance temperature detector or resistive temperature device (RTD) and rings 146 and 148 are positioned in an exposed, or thinly-covered, manner on cooking surface 104. Accordingly, when a food deposit occurs and contact is made with either or both of rings 146 and 148, such contact will change the resistance to current travelling therethrough. This change can be used to provide a signal that can detected by the controller as indicative of a spill-over.

A variety of techniques may be used to provide non-metallic material 102 with the electrically conductive, concentric rings described above. By way of example, rings could be applied by silk screening of the metal (in the form of a metallic ink) onto the cooking surface 104 and then heat-treating the surface so as to bond the metallic ink onto surface 104. Alternatively, the rings could be applied as a metal foil that is bonded to surface 104. Depending upon the sensing scheme, the concentric ring can rest completely on surface 104 or could be partially embedded within material 102 such that a portion of the ring remains exposed on top cooking surface 104.

In order to protect the concentric rings from damage during use, the present invention provides several protective configurations that may be used with the rings. For example, as shown in FIG. 8, cooking surface 104 can be provided with annular grooves 152 into which e.g., concentric rings 154, 156, and 158 are received. As such, when the bottom surface of cooking utensil 160 is moved or slid across surface 104, rings 154, 156, and 158 are protected from contact. FIG. 8 also illustrates the different, exemplary cross-sectional shapes that may be used for the concentric rings of the invention.

FIGS. 9-11 show additional, exemplary configurations for protecting the concentric rings of a sensor zone. Each of these configurations include projections in the form of dimples 162 and 164 that project from surface 104 and are positioned adjacent to e.g., a ring 166. The dimples not only provide protection from the sliding or movement of the bottom of utensil 160, but also provides a slight air gap between the ring 166 and the utensil 160 which can be necessary for certain detection schemes such as capacitance and conductivity sensing. Other projection types can be used as well. In FIG. 9, ring 166 has been e.g., silk screened or printed onto surface 104. For FIG. 10, ring 166 is adhered to surface 104 using a small film of glue 168. In the exemplary embodiment of FIG. 11 conductive ring 166 is shown embedded in cooking surface 104 and is provided with an angled edge 170 that helps constrain ring 166 into the non-metallic material 102.

In still other embodiments, the concentric rings could be completely encased within the non-metallic material forming cooking surface 104. Accordingly, FIG. 12 illustrates an exemplary embodiment in which conductive rings 172 and 174 are encased within the non-metallic material 102 providing cooking surface 104. Electrically conductive ring 172 is provided with a T-shaped configuration that maximizes the surface area with respect to the area being monitored. Alternatively, conductive ring 174 is provided with a rounded top that may also be used in certain applications.

FIG. 13 illustrates another exemplary embodiment of the present invention in which the electrically conductive rings 176 and 178 are applied to a bottom surface 105 of the non-metallic material 102. For this particular embodiment, rings 176 and 178 have been created on a circuit board 180 that is pressed against bottom 105 by spring 182. Alternatively the printed circuit board 180 could be adhered to bottom 105. Alternatively, rings 176 and 178 could be constructed of metalized foil adhered to bottom 105.

Still other configurations for applying conductive rings to the non-metallic material of the cook top appliance 100 may also be used. Also, the concentric rings shown in e.g., FIGS. 4-7 could have other shapes such as waves or zig-zags along the ring that would increase the available sensing area and provide aesthetic effects. By way of further example, the exemplary embodiment of FIG. 7 could have a single, wide ring surrounding the heating element in instead of two. Other configurations may be used as well.

Accordingly, as set forth above, the present invention provides a variety of configurations of the sensor zone. As stated, a controller is placed in communication with the sensor zone. When a food deposit occurs onto the sensor zone, a signal is created that can be detected by the controller to indicate the present of the spill-over. The controller can then undertake one or more remedial actions. For example, the controller can terminate the operation of the heating source or reduce the amount of heat provided by the heating source. As an alternative, or additionally, the controller can also signal the user that a spill-over has occurred using a visual and/or audible alarm. The user can then take additional actions such as e.g., removing the utensil and/or cleaning the food deposit so as to prevent or minimize damage to the cooking surface 104.

Thus, this written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cook top appliance having a cooking surface, the appliance comprising:
a heating source for applying a heat input to a cooking utensil;
a sensor zone surrounding the heating source, said sensor zone including at least one sensor for detecting a food deposit on the cooking surface in the vicinity of the heating source;
a controller in communication with said sensor zone, said controller configured for:
detecting a signal from said sensor zone that is indicative of the food deposit on the cooking surface; and
altering the heat input provided by said heating source once a signal indicative of the food deposit is detected.

2. A cook top appliance having a cooking surface as in claim 1, further comprising:
an alarm in communication with said controller; and
wherein said controller is further configured for activating said alarm once a signal indicative of the food deposit is detected.

3. A cook top appliance having a cooking surface as in claim 1, wherein the altering of the heat input by the controller comprises turning off the heating source.

4. A cook top appliance having a cooking surface as in claim 1, wherein said sensor zone comprises a plurality of light reflectance sensors surrounding the heating source and arranged so as to provide a signal indicative of a change of reflectance of light in the presence of the food deposit on the cooking surface.

5. A cook top appliance having a cooking surface as in claim 1, wherein said sensor comprises:
two or more electrically conductive, concentric and interdigitated rings encircling the heating source, said concentric rings providing a signal to said controller based on a change in capacitance, inductance, resistance, conductivity, voltage, current, or resonance when the food deposit on the cooking surface occurs.

6. A cook top appliance having a cooking surface as in claim 5, wherein said cooking surface is formed by a non-conductive material, and wherein said concentric rings each comprise a metal layer attached to the non-conductive material forming the cooking surface of the cook top.

7. A cook top appliance having a cooking surface as in claim 5, wherein said cooking surface is formed by a non-conductive material, and wherein each concentric ring comprises a metal layer that is embedded into the non-conductive material forming the cooking surface of the cook top while leaving at least a portion of each concentric ring exposed.

8. A cook top appliance having a cooking surface as in claim 5, further comprising:
a groove surrounding the heating source and defined by the cooking surface of the cook top; and
wherein one or more of said concentric rings is located at least partially within said groove to support the utensil over the sensor zone and out of contact with said concentric rings.

9. A cook top appliance having a cooking surface as in claim 5, further comprising:
a plurality of projections from the cooking surface, said projections positioned adjacent said concentric rings and configured to support the utensil over the sensor zone and out of contact with said concentric rings.

10. A cook top appliance having a cooking surface as in claim 5, further comprising:
a non-metallic material forming the cooking surface, and where said concentric rings are encased within said non-metallic material.

11. A cook top appliance having a cooking surface as in claim 10, wherein said concentric rings extend through a bottom surface of the non-metallic material, the bottom surface being on an opposite side of the non-metallic material from the cooking surface.

12. A cook top appliance having a cooking surface as in claim 5, further comprising:
a non-electrically conductive material forming the cooking surface; and
wherein said concentric rings are attached to a bottom surface of the non-electrically conductive material, the bottom surface being on an opposite side of the non-electrically conductive material from the cooking surface.

13. A cook top appliance having a cooking surface as in claim 5, further comprising:
a non-metallic material forming the cooking surface;
a circuit board onto which said concentric rings are formed; and
wherein said circuit board is positioned against a bottom surface of the non-metallic material, the bottom surface being on an opposite side of the non-metallic material from the cooking surface.

14. A cook top appliance having a cooking surface as in claim 1, wherein said sensor zone comprises a plurality of electrically conductive, concentric rings that are positioned so that at least a portion of said rings are outside a footprint of the utensil when the utensil is positioned centrally on said heating source.

15. A cook top appliance having a cooking surface as in claim 1, wherein said sensor zone comprises an electrically conductive, temperature sensitive, metallic structure encircling the heating source and arranged so as to provide a signal indicative of a rate of change of temperature when food is deposited onto the cooking surface.

16. A cook top appliance having a cooking surface as in claim 10, wherein said sensor zone comprises a plurality of temperature sensors surrounding the heating source, in thermal communication with the cooking surface, and arranged so as to provide a signal indicative of a rate of change of temperature of the cooking surface at the time the food is deposited onto the cooking surface.

17. A cook top appliance having a cooking surface as in claim 16, wherein said sensor is selected from the group consisting of thermocouples, resistance temperature devices (RTDs), thermistors, diodes, and transistors.

18. A method for operating a cook top appliance having a heating source surrounded by a sensor zone comprising at least one sensor, the method comprising the steps of:
providing heat to a substance in a utensil placed on the heating source;
monitoring the sensor zone to detect a deposition of food and, if a deposition of food is detected, then
adjusting the heating source so as reduce or terminate the heating of the substance in the utensil; and,
providing a notification to a user of the appliance.

19. A method for operating a cook top appliance as in claim 18, wherein said monitoring step comprises using the sensor to detect a change in temperature, light intensity, resistance, conductivity, current, voltage, capacitance, inductance, or resonance caused by the food deposition.

20. A method for operating a cook top appliance as in claim 18, wherein said monitoring step comprises using the sensor to determine the rate of change of temperature, light intensity, resistance, voltage, or current as a function of time to determine that a deposition of food has occurred.
